(19) United States
(12) Patent Application Publication
(10) Pub. No.: US 2020/0347255 A1
(43) Pub. Date: Nov. 5, 2020

(54) SENSOR INK FOR DETECTING COMPONENTS IN SEALED PACKAGING PROCESS FOR PRODUCING A FLUORESCENCE SENSOR COMPRISING THE SENSOR INK AND SENSOR

(71) Applicant: TECHNISCHE FARBEN GES.B.R., Grambach (AT)

(72) Inventors: Gerhard ZEHETNER, Graz (AT); Claudia PEKARI-KROTTMAIER, Hart Bei Graz (AT); Johannes KROTTMAIER, Hart Bei Graz (AT); Iris Maria RIBITSCH, Wien (AT)

(73) Assignee: TECHNISCHE FARBEN GES.B.R., Grambach (AT)

(21) Appl. No.: 16/760,051

(22) PCT Filed: Oct. 25, 2018
(86) PCT No.: PCT/AT2018/000088

§ 371 Date: Apr. 29, 2020

(30) Foreign Application Priority Data
Oct. 30, 2017 (AT) A 422/2017

(51) Int. Cl. C09D 11/50; C09D 11/033; C09D 11/38; C09D 11/326; B41M 3/14

(52) U.S. Cl. CPC C09D 11/50; C09D 11/033; B41M 3/144; C09D 11/326; C09D 11/38

(57) ABSTRACT

In a sensor ink for the quantitative detection of components in a closed package, comprising at least one fluorophore, a polymeric carrier matrix and at least one organic solvent, a silicon-organic system or a homopolymer or copolymer selected from the group of polystyrenes, polysulfones, polyether imides, polyether sulfones, polyvinylchloride (PVC), polyphenylene oxide (PPO), polysulfone derivatives, polyethylene terephthalate, biobased polymers, polylactic acid, cellulose ester and cellulose ether with a molecular weight of between 80,000 and 300,000, is contained as the carrier matrix, and the fluorophore is present in an amount of 1.5 wt. % to 7 wt. %, based on the polymer concentration, wherein the carrier matrix and the fluorophore together with the organic solvent form a solution having a viscosity of between 20 and 70 mPa·s, and a method for producing a quantitative fluorescence sensor, and a sensor.

The present invention relates to a sensor ink for the quantitative detection of components in a closed packaging/container, for flexoprinting or offset printing, comprising at least one fluorophore, a polymeric carrier matrix and at least one organic solvent, and a method for producing a fluorescent sensor using said sensor ink, and a thus produced sensor.

Fluorescent or luminescent sensors used for measuring gas concentrations within, for instance, food packaging or pharmaceuticals have been known for some time and are, in particular, employed for determining whether, for instance, the packaging is tightly closed or whether the products contained in the packaging are already spoiled and can no longer be used. Since, at the same time, the number of already prepackaged, in particular gas-tightly packaged, products going on sale has steadily increased and, for instance in the food sector, sausages, cheeses or meats are almost exclusively sold in already packaged form, it has become more and more important for both producers and consumers to be able to immediately find out whether the packaged products are still edible, whether the packaging is tightly closed and/or whether the hygienic requirements are met.

In recent times, methods by which sensors can be applied to the inside of packages have, therefore, been developed, which sensors can subsequently be read out either contactlessly, or by contacting the film by a read-out detector, so as to find out immediately, as a function of the emitted or non-emitted rays, whether the products contained in the packaging are fine, for instance whether the oxygen content inside the packaging is too high, which would suggest leaky packaging, or the like.

Such sensors, which are usually comprised of luminescent or fluorescent dyes contained in a polymeric matrix, have been applied to the inside of films by special printing processes such as screen-printing or sputtering, thus obtaining sensor points or patterns on the inside of the packaging. The sensors have relatively great thicknesses of about 40 μm and, in addition to extremely large amounts of polymer and fluorescent or luminescent dye, also require long drying times such that these sensors can hardly be used in a continuous process, in particular in mass production, since the slowness of the production process and, in particular, the large and thick sensor points have turned out to be disadvantageous.

From WO 98/18871 A1, an ink for ink-jet printing can be taken, which, in addition to an organic solvent, a polymer soluble therein and an organic electrolyte soluble therein, also comprises a plurality of fluorophores that can be used in inks for ink jet printing.

From U.S. Pat. No. 4,186,020 A, a fluorescent printing ink can likewise be taken, which is suitable for use in ink-jet printing and which emits in ultraviolet light and comprises a soluble organic phosphorus, soluble organic brighteners as well as soluble fluorescent dye components and a binder. From that document, no information on the viscosity of that ink can be taken.

Thus, there is still the need for producing a sensor or sensor ink by which it is possible to form extremely thin sensor points on plastic films, which thin sensor points have, however, sufficient concentrations of fluorescence or luminescence dyes so that they can be read out safely and free of doubt, and which sensor points, on the other hand, can be dried rapidly enough so as to be already present in the dried state when leaving the printer. Finally, the method for producing such sensors has to be implementable on common mass printing technologies such as flexoprinting or offset printing in order to be able to provide a sufficient number of sensors for mass-produced goods.

The invention, therefore, aims to provide a sensor ink that meets the above needs and enables quantitative measurements, and a method for producing a fluorescent sensor using such a sensor ink, and a sensor produced with such a sensor ink.

To solve this object, the sensor ink according to the invention is essentially characterized in that a silicon-organic system or a homopolymer or copolymer selected from the group of polystyrenes, polysulfones, polyether imides, polyether sulfones, polyvinylchloride (PVC), polyphenylene oxide (PPO), polysulfone derivatives, polyethylene terephthalate, biobased polymers such as polylactic acid, cellulose ester and cellulose ether with a molecular weight of between 80,000 and 300,000, preferably between 100,000 and 240,000, is contained as a carrier matrix, that the fluorophore is present in an amount of 1.0 wt. % to 7 wt. %, based on the polymer concentration, and that the carrier matrix and the fluorophore together with the organic solvent form a solution having a viscosity of between 20 to 70 mPa·s. In that a silicon-organic system or a homopolymer or copolymer selected from the group of polystyrenes, polysulfones, polyether imides, polyether sulfones, polyvinylchloride (PVC), polyphenylene oxide (PPO), polysulfone derivatives, polyolefins, polyethylene terephthalate, biobased polymers such as polylactic acid, cellulose ester and cellulose ether with a molecular weight of between 80,000 and 300,000, preferably between 100,000 and 240,000, is contained as a carrier material for the sensor ink, it has become possible to provide a base for the sensor formed by the sensor ink, which is deformable after its application on, for instance, a plastic film and will not even break or detach from the packaging material during excessive movement of the film, e.g. packaging material, on which such a sensor point was applied. A sensor comprised of such a polymer or copolymer is flexible, elastic and adheres well to various plastic surfaces. The sensor can, however, also be used on non-deformable or hardly deformable, transparent or semi-transparent materials such as glass containers or relatively rigid plastic containers.

In that, moreover, the fluorophore is present in the polymeric matrix in an amount of 1.5 wt. % to 7 wt. %, based on the polymer concentration, it has become possible to integrate sufficient quantities of fluorophore in the sensor ink so as be able, when forming a sensor using said ink, to measure a reproducible signal that is not too weak and, in particular, does not allow for erroneous interpretations. In this respect, the polymer concentration is substantially selected such that a fluorescence signal received by a detector is larger by at least a factor 5 than the background signal. If the concentration of the fluorophore in the sensor ink drops to below 1.0 wt. %, a sufficiently strong fluorescence or luminescence signal of the sensor can no longer be guaranteed, and if the content increases to above 7 wt. %, based on the polymer concentration, it cannot be prevented that an aggregation or accumulation of individual sensor molecules and an agglutination of the same in the interior of a sensor comprised of the sensor ink according to the invention are caused, which might lead to the self-extinction of a fluorescence or luminescence signal so that measurements might become inaccurate and, in particular, not representative.

In that, moreover, in addition to the carrier matrix and the fluorophore an organic solvent is contained, by which the viscosity of the sensor ink is adjusted to a value ranging between 20 and 70 mPa·s, it has become possible to produce a readily printable ink that can, in particular, be used in mass printing processes, in which it is necessary that the used inks are highly fluid and, in particular, dry extremely rapidly upon application, wherein the solvent has to be selected to dry residue-free and enable the production of sensors with extremely small layer thicknesses of a few μm, e.g. 1-10 μm.

In a mass printing process such as flexoprinting or offset printing, it is usually required to adjust the viscosity of the solution slightly higher than for ink-jet printing in order to be able to produce discrete and reproducible sensor points. It is essential also in these printing methods to adjust the viscosity of the solution such that trickling or bleeding of the individual points or stringing during printing are prevented in order to always achieve reproducible results in which the amount of fluorophore contained in a single sensor point is reproducible so as to obtain accordingly reproducible results.

The term “sensor ink” as used in the present application comprises any solution consisting of a polymer, a fluorophore and a low-boiling solvent irrespectively of the fact whether said solution is a dyed or an undyed solution. The only criterion is that the fluorophore molecules contained in said sensor ink can be excited to emit a fluorescent or luminescent light and are present in the sensor ink in a molecularly dissolved state.

In that, as in correspondence with a further development of the invention, the sensor ink is configured such that the fluorophore contained therein is selected from the group of metal porphyrins, phenanthroline complexes such as diphenyl phenanthroline, ruthenium(II) complexes, fluorescein derivatives, coumarin derivatives and phenylmethane dyes (sic). In that the fluorophore is selected from the above-identified group or derivatives of this group, in particular various derivatives of metalloporphyrins, it has become possible to provide a sensor ink in which even high concentrations of about 3 to 7% of the fluorophore are present in the dissolved state in the polymeric matrix, and which fluorophore, in particular, does not tend to aggregate formation and/or self-extinction after the production of a sensor.

By using organic solvents selected from the group of methyl ethyl ketone, chloroform, ethyl acetate or fluorinated organic compounds such as octofluorotoluene, which are selected to enable the dissolution of the respective matrix polymer, it has become possible to produce a sensor ink in which the viscosity can be exactly adjusted to a mass printing method such as flexoprinting or offset printing. In addition, such solvents are selected to have a boiling point of below 100° C. so that the sensor is already completely dried, i.e. the solvent evaporated, in the interior of the printing unit/printing machine, in the drying section provided therefor, rather than requiring a separate drying process for the sensor after its application to the carrier film. Moreover, such organic solvents ensure that during their evaporation a homogenous surface is left and their evaporation occurs uniformly so as to achieve a homogenous sensor in which the fluorophore molecules even in the dried form are present as discrete molecules sufficiently spaced-apart relative to each other in order not to tend to self-extinction but rather emit a strong and reproducible signal when using the sensor.

In order to, in particular, safely prevent self-extinction of the fluorophore, or the excited fluorophore molecules, during a measurement, the sensor ink according to the present invention is substantially further developed to the effect that the fluorophore is present in the polymer solution in a molecularly dissolved state. Such a molecular solution can only be achieved by the precise interaction of the selected polymer or homo- or copolymer with the selected solvent, and the polymer and the solvent, in particular, have to be selected such that the fluorophore will be present in the molecularly dissolved state and the fluorophore molecules will be mutually spaced-apart, not only in solution but also after drying of a sensor point on the carrier film. In this respect, it has to be safeguarded that no migration of the fluorophore molecules occurs within the carrier matrix and no formation of agglomerates takes place either, in order to ensure a consistent, reproducible measurement depending only on the concentration of the fluorophore in the polymer and on the layer thickness thereof.

By the term “molecularly dissolved” it is understood that the fluorophore molecules are present in the polymer solution and in the solidified polymer as discrete, individual molecules with no agglomerates, adducts and the like formed.

To this end, it is beneficial that, as in correspondence with a further development of the invention, the sensor ink is configured such that its elasticity in a viscoelastic system, expressed as G′, at frequencies ≤50 Hz is smaller than the viscosity value expressed as G″. When adjusting such elasticity, it is ensured that printing is feasible without stringing and that a sensor point formed using said sensor ink is sufficiently elastic to follow the movements of the carrier film without breaking or detaching. In order to further avoid detaching, the surface properties of the films on which such sensors are printed can, for instance, be improved by a corona treatment.

Such a sensor ink is suitable for the production of fluorescent sensors by mass printing processes, wherein, according to the invention, a method for producing such a fluorescent sensor is essentially characterized in that it comprises the steps of
a) producing a sensor ink according to any one of claims 1 to 7 by mixing all components under stirring until a homogenous solution is formed,
b) applying the sensor ink by a mass printing process to a heat-sealable plastic film having a surface tension of >36 N/m², or a plastic container or glass container,
c) evaporating the solvent contained in the sensor ink in a pressure device, and
d) optionally rolling the plastic film printed with the sensor ink up on reels.

The method according to the invention for the first time enables a sensor ink to be applied to a plastic film or plastic container or glass container by mass printing processes, i.e., e.g. flexoprinting or offset printing, whereby not only the application of the sensor ink to the film is feasible, but it is, in particular, possible that, due to the specific composition of the sensor ink, the solvent contained in the ink evaporates or is evaporated in the drying section of the printing unit and a sensor, or a plurality of sensors having a very small thickness, can be formed at extremely high printing speeds, which are immediately available for further use.

In order to safely and completely ensure the evaporation of the solvent in the interior of the printer, in particular within the short time a film needs for transportation over the drying sector of the printer, the method is further developed to the effect that evaporating the solvent is performed in the interior of the printer at a temperature of <90° C. within the printer. At an evaporation temperature of below 90° C. it is ensured that the selected solvents mentioned above, i.e. methyl ethyl ketone, ethyl acetate, chloroform or fluorinated organic compounds, are rapidly and safely evaporated without leaving any residues and without causing irregularities, in particular surface roughness, on the formed sensor, or an agglomeration of the fluorophore contained in the sensor.

Such an ink can, in particular, be used in a flexoprinting or offset printing process for printing the ink on a plastic film or a plastic or glass container. It has not been possible to carry out such a method with the hitherto known inks, and, in particular, there has also been a prejudice against the possibility of reaching such rapid drying of the sensor material as to enable the implementation of a mass printing process, since the individual sides of a film or turns of a roller or the separated plastic or glass containers would otherwise adhere to each other, thus destroying or possibly tearing off the sensors.

As in correspondence with a further development of the invention, films selected from the group of polysulfones (PS), polypropylene (PP), polyethylene (PE), polyamide (PA), polyethylene terephthalate incl. biopolymers such as polylactic acid (PLA), polyethylene terephthalate (BioPET), cellophane) turned out to be particularly suitable for carrying out the method according to the present invention. Such films are sufficiently flexible for printing, have sufficient temperature stability against deterioration during printing and can be thermally sealed for the production of, for instance, food packaging or medical device packaging.

In order to, in particular, use the method for producing fluorescent sensors that can be employed for the quantitative detection of, for instance, the oxygen content in packaging or the detection of whether a package is tightly sealed, the plastic film according to a preferred further development of the method is selected to have a high oxygen barrier effect. Films having an oxygen permeability lower than 10 cm³/m²/day/atm are particularly preferred in this respect.

Finally, the invention relates to a sensor, in particular fluorescent sensor, produced by a method according to the present invention and formed within packaging sealable by a plastic film, or a container. Such a sensor is essentially characterized in that the fluorophore is present in the polymeric matrix as a discrete dye molecule in an amount from 2 to 5 wt. % of the polymeric matrix and has a thickness smaller than 6 μm. Sensors with such small thicknesses could not be produced by conventional printing methods such as screen-printing, and it has, in particular, not been possible to provide sufficient concentration of the fluorophore in the sensor material and, at the same time, form an extremely thin sensor. It was only by the selection of the polymeric matrix according to the present invention and the solvent as well as the method of applying the sensor ink to a plastic foil according to the present invention that it has become possible to produce sensors with such small layer thicknesses and, at the same time, high fluorophore concentrations. According to the invention, such a sensor can be applied to the carrier films by mass printing technologies such as flexoprinting or offset printing, thus being suitable for mass production.

A printing solution according to the invention produced by the method of the invention contains 16-20 wt. % polymer and 80 to 85 wt. % solvent. Such a printing solution enables the achievement of sensors having thicknesses of between 1.5 and 5 μm, preferably 2 to 3 μm.

1. A sensor ink for the quantitative detection of components in a closed package/container for flexoprinting or offset printing, comprising at least one fluorophore, a polymeric carrier matrix and at least one organic solvent, wherein a silicon-organic system or a homopolymer or copolymer selected from the group of polystyrenes, polysulfones, polyether imides, polyether sulfones, polyvinylchloride (PVC), polyphenylene oxide (PPO), polysulfone derivatives, polyethylene terephthalate, biobased polymers, polylactic acid, cellulose ester and cellulose ether with a molecular weight of between 80,000 and 300,000, is contained as a carrier matrix, the fluorophore is present in an amount of 1.0 wt. % to 7 wt. %, based on the polymer concentration, and the carrier matrix and the fluorophore together with the organic solvent form a solution having a viscosity of between 20 to 70 mPa·s.

2. The sensor ink according to claim 1, wherein the fluorophore is selected from the group of metal porphyrines, phenanthroline complexes selected from diphenyl phenanthroline, ruthenium(II) complexes, fluorescein derivatives, coumarin derivatives and phenylmethane dyes.

3. The sensor ink according to claim 1, wherein the organic solvent is selected from the group of methyl ethyl ketone, chloroform, ethyl acetate or fluorinated organic compounds.

4. The sensor ink according to claim 1, wherein the fluorophore is present in the polymer solution in a molecularly dissolved state.

5. The sensor ink according to claim 1, wherein its elasticity in a viscoelastic system, expressed as G′, at frequencies ≤50 Hz is smaller than the viscosity value expressed as G″.

6. A method for producing a fluorescent sensor, comprising the steps of:
a) producing a sensor ink according to claim 1 by mixing all components by stirring until a homogenous solution is formed;
b) applying the sensor ink by a mass printing process to a heat-sealable plastic film having a surface tension of >36 N/m², or a plastic container or glass container;
c) evaporating the solvent contained in the sensor ink; and
d) rolling the plastic film printed with the sensor ink up on reels.

7. The method according to claim 6, evaporating the solvent is performed in the interior of printer at a temperature of <90° C.

8. The method according to claim 6, applying the sensor ink to the plastic film, plastic container or glass container by a method selected from flexoprinting or offset printing.

9. The method according to claim 6, printing the film selected from the group of polysulfones (PS), polypropylene (PP), polyethylene (PE), polyamide (PA), polyethylene terephthalate incl. biopolymers such as polylactic acid (PLA), polyethylene terephthalate (BioPET), cellophane).

10. The method according to claim 9, using the plastic film having a high oxygen barrier effect, or an oxygen permeability lower than 10 cm³/m²/day/atm.

11. A fluorescent sensor, produced by the method of claim 6 on a heat-sealable plastic film or plastic container or glass container, wherein the fluorophore is present in a polymeric matrix as discrete dye molecules in an amount from 2 to 5 wt. % of the polymeric matrix.

12. The fluorescent sensor according to claim 11, having a layer thickness of a dried sensor ink on the plastic film smaller than 6 μm.
